(19) United States
(12) Patent Application Publication
(10) Pub. No.: US 2025/0328114 A1
(43) Pub. Date: Oct. 23, 2025

(54) METHODS AND SYSTEMS FOR AUTOMATED GARMENT ASSEMBLY

(71) Applicant: CreateMe Technologies Inc., Newark, CA (US)

(72) Inventors: Akhil Devarakonda, Freemont, CA (US); Vishnu Devarakonda, Freemont, CA (US); Nicholas D. CHOPE, Portland, OR (US)

(21) Appl. No.: 18/638,011

(22) Filed: Apr. 17, 2024

(51) Int. Cl. G05B 13/02

(52) U.S. Cl. CPC G05B 13/028

(57) ABSTRACT

A device includes one or more processors coupled to a memory and configured to obtain data indicative of a garment to be manufactured. The one or more processors are configured to generate, using a machine learning model trained on the data, output data indicative of localization information, one or more properties associated with a fabric, and one or more actions associated with the fabric to be performed on the fabric in manufacturing the garment. The one or more processors are configured to cause a second device to perform an action of the one or more actions associated with the fabric.

### FIELD OF THE DISCLOSURE

The present disclosure is generally related to automated garment assembly.

### BACKGROUND

The garment assembly industry has traditionally relied on skilled human labor to transform fabric into finished clothing. However, this traditional approach faces several limitations in today's dynamic fashion industry, such as labor intensity and dependence on a skilled workforce. Traditional methods involve numerous manual tasks like spreading fabric layers, cutting individual pieces, sewing seams, and attaching trims. This reliance on manual labor makes the process labor-intensive and susceptible to human error. Another example is limited scalability and production flexibility. Traditional assembly lines are inflexible and require significant time and resources to adapt to changes in production volume or garment style. Scaling production up or down can be difficult, and introducing new styles often necessitates reprogramming manual processes or retraining workers. Another example is inconsistency and quality control challenges. Despite the skill of human workers, manual assembly inherently introduces variability in stitch quality, seam placement, and overall garment dimensions. Maintaining consistent quality across large production runs can be challenging, leading to potential rework and higher production costs.

Accordingly, there is a need for methods and systems configured to automate garment assembly.

### SUMMARY

In a particular implementation, a device includes one or more processors coupled to a memory. The one or more processors are configured to obtain data indicative of a garment to be manufactured. The one or more processors are further configured to generate, using a machine learning model trained on the data, output data indicative of localization information, one or more properties associated with a fabric, and one or more actions associated with the fabric to be performed on the fabric in manufacturing the garment. The one or more processors are further configured to perform an action of the one or more actions associated with the fabric.

In a particular implementation, a device includes one or more processors coupled to a memory. The one or more processors are configured to obtain data indicative of a garment to be manufactured. The one or more processors are further configured to generate, based on the data, synthetic data indicative of a fabric to be used in manufacturing the garment and one or more properties associated with the fabric. The one or more processors are further configured to train a machine learning model using the synthetic data, the machine learning model configured to output data indicative of localization information, one or more properties associated with the fabric, and one or more actions associated with the fabric to be performed on the fabric in manufacturing the garment.

In another particular implementation, a method includes obtaining, at a device, data indicative of a garment to be manufactured. The method includes generating, at the device, synthetic data indicative of a fabric to be used in manufacturing the garment and one or more properties associated with the fabric the method includes generating, at the device using a machine learning model, output data indicative of localization information, the one or more properties associated with the fabric, and one or more actions to be performed on the fabric in manufacturing the garment.

The features, functions, and advantages described herein can be achieved independently in various implementations or may be combined in yet other implementations, further details of which can be found with reference to the following description and drawings.

### BRIEF DESCRIPTION OF THE DRAWINGS

FIG. 1 is a diagram that illustrates a system for automated garment manufacturing.

FIG. 2 is a diagram that illustrates a particular implementation of a system for automated garment manufacturing.

FIG. 3 is a diagram that illustrates another particular implementation of a system for automated garment manufacturing.

FIG. 4 is a diagram that illustrates another particular implementation of a system for automated garment manufacturing.

FIG. 5 is a diagram that illustrates another particular implementation of a system for automated garment manufacturing.

FIG. 6 is a flow chart of a method for automated garment manufacturing.

FIG. 7 is a block diagram of a computing environment including a computing device configured to support aspects of computer-implemented methods and computer-executable program instructions (or code) according to the present disclosure.

### DETAILED DESCRIPTION

The garment assembly industry has traditionally relied on skilled workers to transform fabric into finished clothing. While this approach has proven effective, it faces several limitations in today's fast-paced fashion world. One major hurdle is the labor intensity and dependence on a skilled workforce. Traditional methods involve numerous manual tasks such as spreading fabric, cutting individual pieces, sewing seams, and attaching trims. This reliance on manual labor makes the process not only time-consuming but also prone to human error. Additionally, securing a consistent and skilled workforce can be challenging, especially in regions with high demand.

Accordingly, there is a need for a method and system configured to automate garment assembly.

Aspects disclosed herein present systems and methods for automating garment assembly. The system includes a device that obtains data (e.g., garment data) that defines the garment to be manufactured. This data can include a digital design file (e.g., DXF format) containing garment measurements, seam allowances, and other specifications. Alternatively, the data can include three-dimensional garment models or even two-dimensional sketches that include garment measurements, seam allowances, and other specifications.

Based on the data, the device generates synthetic data representative of the garment to be manufactured. The synthetic data can encompass fabric properties like weight, weave type (e.g., denim, twill), and thread count. In some aspects, the synthetic data can include virtual aspects of the fabric, such as the fabric's texture and drape.

The device can then utilize a machine learning (ML) model that is trained using the synthetic data. In some aspects, the training data can also include real-world fabric data (e.g., for added accuracy). During training, the ML model learns to associate specific garment features (e.g., seams, pockets, zippers) with localization information. The localization information refers to the location of the fabric on another device (e.g., a garment manufacturing device) or to the location on the fabric where an action needs to be performed. For example, the ML model can inform that a folding device is to be adjusted to accommodate to the size of the garment being manufactured.

The device can also use a ML model that is trained using image data to determine that the fabric includes one or more wrinkles. The device can cause a placement apparatus to move along a path associated with locations of the one or more wrinkles to have the one or more wrinkles removed from the fabric, via a blower device that uses compressed air.

The techniques and systems described herein provide a technical advantage of greater efficiency, improved quality control, and increased manufacturing flexibility through the use of processing garment data and generating synthetic fabric data that enables the ML model to generate data that guides garment manufacturing devices with localization information, tailors actions to be performed on a fabric based on the fabric characteristics, and provides additional insights to optimize garment construction for the chosen material.

The figures and the following description illustrate specific exemplary implementations. It will be appreciated that those skilled in the art will be able to devise various arrangements that, although not explicitly described or shown herein, embody the principles described herein and are included within the scope of the claims that follow this description. Furthermore, any examples described herein are intended to aid in understanding the principles of the disclosure and are to be construed as being without limitation. As a result, this disclosure is not limited to the specific implementations or examples described below, but by the claims and their equivalents.

Particular implementations are described herein with reference to the drawings. In the description, common features are designated by common reference numbers throughout the drawings.

As used herein, various terminology is used for the purpose of describing particular implementations only and is not intended to be limiting. For example, the singular forms “a,” “an,” and “the” are intended to include the plural forms as well, unless the context clearly indicates otherwise. Further, some features described herein are singular in some implementations and plural in other implementations. To illustrate, FIG. 8 depicts a computing device 710 including one or more processors (“processor(s)” 720 in FIG. 8), which indicates that in some implementations the computing device 710 includes a single processor 720 and in other implementations the computing device 710 includes multiple processors 720. For ease of reference herein, such features are generally introduced as “one or more” features and are subsequently referred to in the singular or optional plural (as typically indicated by “(s)”) unless aspects related to multiple of the features are being described.

The terms “comprise,” “comprises,” and “comprising” are used interchangeably with “include,” “includes,” or “including.” Additionally, the term “wherein” is used interchangeably with the term “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to a grouping of one or more elements, and the term “plurality” refers to multiple elements.

As used herein, “generating,” “calculating,” “using,” “selecting,” “accessing,” and “determining” are interchangeable unless context indicates otherwise. For example, “generating,” “calculating,” or “determining” a parameter (or a signal) can refer to actively generating, calculating, or determining the parameter (or the signal) or can refer to using, selecting, or accessing the parameter (or signal) that is already generated, such as by another component or device. As used herein, “coupled” can include “communicatively coupled,” “electrically coupled,” or “physically coupled,” and can also (or alternatively) include any combinations thereof. Two devices (or components) can be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled can be included in the same device or in different devices and can be connected via electronics, one or more connectors, or inductive coupling, as illustrative, non-limiting examples. In some implementations, two devices (or components) that are communicatively coupled, such as in electrical communication, can send and receive electrical signals (digital signals or analog signals) directly or indirectly, such as via one or more wires, buses, networks, etc. As used herein, “directly coupled” is used to describe two devices that are coupled (e.g., communicatively coupled, electrically coupled, or physically coupled) without intervening components.

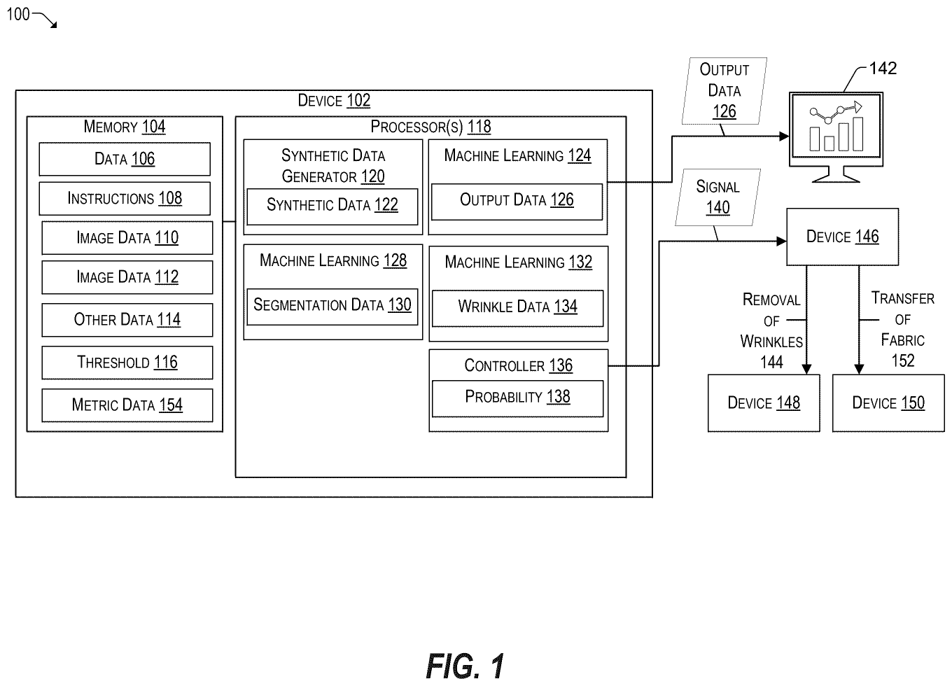

FIG. 1 is a diagram that illustrates a system 100 for automated garment manufacturing. The system 100 includes a device 102 coupled to a device 142, a device 146, or both. The device 102 includes a memory 104 coupled to one or more processors 118.

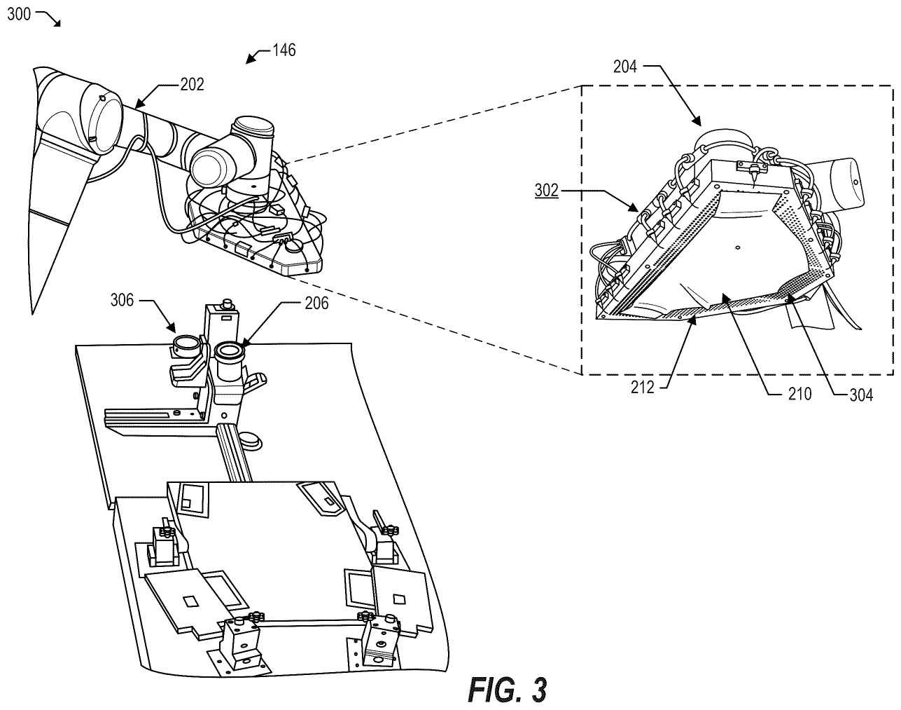

In a particular aspect, the device 102 can include, or be integrated in, at least one of a robotic device, a device associated with the manufacturing of a garment, a tablet, a smart phone, a computer-based tool, a laptop computer, or an input accessory device. The device 142 can include, or be integrated in, at least one of a robotic device, a device associated with the manufacturing of a garment, a tablet, a smart phone, a computer-based tool, a laptop computer, or an input accessory device. The device 146 can include or be integrated in at least one of a robotic device, a device associated with the manufacturing of a garment (e.g., a placement apparatus as described in FIGS. 3-6), a tablet, a smart phone, a computer-based tool, a laptop computer, or an input accessory device.

The memory 104 includes a computer-readable medium (e.g., a computer-readable storage device) that stores instructions 108 that are executable by processor(s) 118. The instructions 108 are executable to initiate, perform, or control operations described herein with reference to a synthetic data generator 120, machine learning 124, machine learning 128, machine learning 132, a controller 136, or a combination thereof. The memory 104 is configured to store data used or generated by the synthetic data generator 120, the machine learning 124, the machine learning 128, the machine learning 132, or a combination thereof. For example, the memory 104 is configured to store the data 106 indicative of a garment to be manufactured, image data 110 indicative of an image depicting the fabric on the device 146, image data 112 indicative of the fabric including one or more wrinkles, synthetic data generated by the synthetic data generator 120, output data 126 generated by the machine learning 124, segmentation data 130 generated by the machine learning 128, wrinkle data 134 generated by the machine learning 132, or a combination thereof. In some aspects, the memory stores other data 114 indicative of information associated with the manufacturing the garment, threshold 116, metric data 154 indicative of production metrics, quality metrics, machine performance metrics, material usage metrics, or process flow metrics, or a combination thereof.

The processor(s) 118 include the synthetic data generator 120, the machine learning 124, the machine learning 128, the machine learning 132, the controller 136, or a combination thereof. The synthetic data generator 120 is configured to generate the synthetic data 122 indicative of a fabric to be used in manufacturing the garment and one or more properties associated with the fabric. The machine learning 124 is configured to be trained on the synthetic data 122, the other data 114, or both and generate the output data 126. The output data 126 is indicative of localization information, one or more properties associated with a fabric, and one or more actions associated with the fabric to be performed on the fabric in manufacturing the garment.

The machine learning 128 is configured to generate segmentation data 130. In some aspects, the generation of the segmentation data 130 is based on the image data 110 indicative of an image depicting the fabric on the device 146 or another device associated with the manufacturing of a garment. The segmentation data 130 is indicative of pixel values associated with a location of the fabric on the device 146 within the image.

The machine learning 132 is configured to determine wrinkle data 134 indicative of the fabric including one or more wrinkles. The determination of the wrinkle data 134 can be based on the image data 110, the image data 112, or a combination thereof. The image data 110, 112 of the fabric can be a captured by a camera using one or more imaging techniques. For example, the one or more imaging techniques can include thermal imaging, three-dimensional (3D) imaging, two-dimensional (2D) imaging, structured light imaging, laser scanning, digital image correlation, multispectral imaging, machine vision with standard cameras, or a combination thereof.

During operation, the device 102 obtains the data 106 indicative of a garment to be manufactured. The data 106 can include a digital design file (e.g., DXF format) containing garment measurements, seam allowances, and other specifications. Alternatively, the data 106 can include 3D garment models or even 2D sketches that include garment measurements, seam allowances, and other specifications. The data 106 can be used by the synthetic data generator 120 to generate the synthetic data 122. For example, the synthetic data generator 120 obtains the data 106 in response to a user request to manufacture a garment. To illustrate, the synthetic data generator 120, in response to receiving a user input requesting for a garment to be manufactured, obtains the data 106. The synthetic data generator 120 generates synthetic data 122 indicative of a fabric to be used in manufacturing the garment and one or more properties associated with the fabric. The one or more properties includes one or more of fabric color, pattern or design on the fabric, fabric weight, fabric material and characteristics associated with the fabric material, fabric density, or a combination thereof. In some aspects, the generation of the synthetic data 122 further includes receiving user input to augment the synthetic data 122, such as the other data 114 indicative of information associated with the manufacturing the garment, historical data indicative of previously obtained data indicative of other garments to be manufactured, or both. The previously obtained data includes one or more previous fabrics and one or more previous properties for each of the one or more previous fabrics.

The synthetic data 122 can be sent to the machine learning 124. The machine learning 124 can be trained using the synthetic data 122. Based on the training, the machine learning 124 generates the output data 126 indicative of localization information, one or more properties associated with the fabric, one or more actions associated with the fabric to be performed on the fabric in manufacturing the garment, or a combination thereof. The machine learning 124 can send the output data 126 to the device 142 to be displayed to a user. The device 142, based on the output data 126, displays a visual representation of the garment and information about the garment and manufacturing of the garment, such as the localization information, the one or more properties associated with the fabric, one or more actions associated with the fabric to be performed on the fabric in manufacturing the garment, or a combination thereof. In some aspects, the machine learning 124 sends the output data 126 to the controller 136 and the controller 136 then sends the output data 126 to the device 142. In other aspects, the processor 118 includes a display output generator and the machine learning 124 sends the output data 126 to the display output generator. The display output generator is configured to generate a display output based on the output data 126. The display output generator sends the display output to the device 142 to be displayed, as described above.

The machine learning 128 obtains the image data 110 indicative of an image depicting the fabric on the device 146. The machine learning 128 generates the segmentation data 130 indicative of pixel values associated with a location of the fabric on the device 146 within the image. In some aspects, prior to the generation of the segmentation data 130, one or more process steps are performed on the image data 110. The device 102, the machine learning 128, the controller 136, or another device coupled to the device 102 can perform the one or more processing steps. The one or more processing steps includes one or more of performing a gray-scale processing step to the image data 110, performing an RGB color model in which red, green and blue primary colors of light are added together in various ways to reproduce a broad array of colors, adjusting one or more-pixel values within the image data 110 based on one or more properties associated with the fabric, such as a fabric material, fabric density, etc., or a combination thereof.

The machine learning 128 sends the segmentation data 130 to the controller 136. The controller 136 then determines a probability 138 that the fabric is in a location on the device 146 that is suitable for the action. The controller 136 determines whether the probability 138 satisfies the threshold 116. In some implementations, the probability 138 does satisfy the threshold 116. In those implementations, the performing of the action includes removal of wrinkles 144, transfer of fabric 152, one or more processes associated with the manufacturing of the garment, or a combination thereof. In other implementations, the probability 138 does not satisfy the threshold 116. In those implementations, the action includes discarding of the fabric, notifying a user, or both.

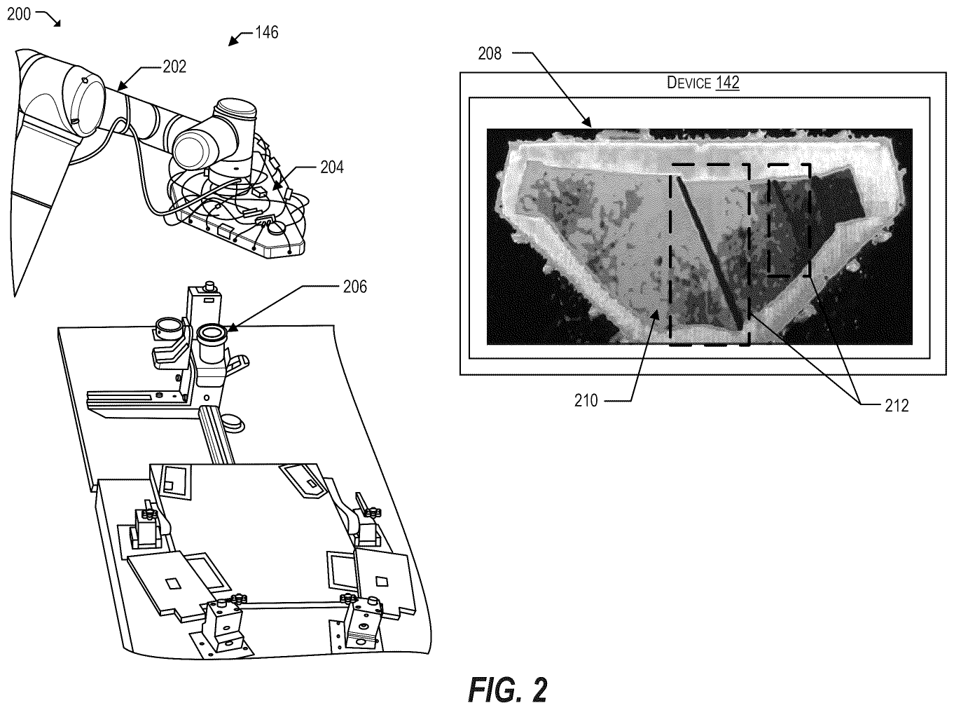

The machine learning 132 obtains the image data 112 indicative of an image depicting the fabric on the device 146. The machine learning 132 determines wrinkle data 134 indicative of the fabric including one or more wrinkles based on the image data 112, as described in more detail in FIG. 2. The machine learning 132 sends the wrinkle data 134 to the controller 136. The controller 136 sends a signal 140 to the device 146 to move along a path associated with locations of the one or more wrinkles to have the one or more wrinkles removed from the fabric, via the device 148 that uses compressed air, as described in more detail in FIG. 3.

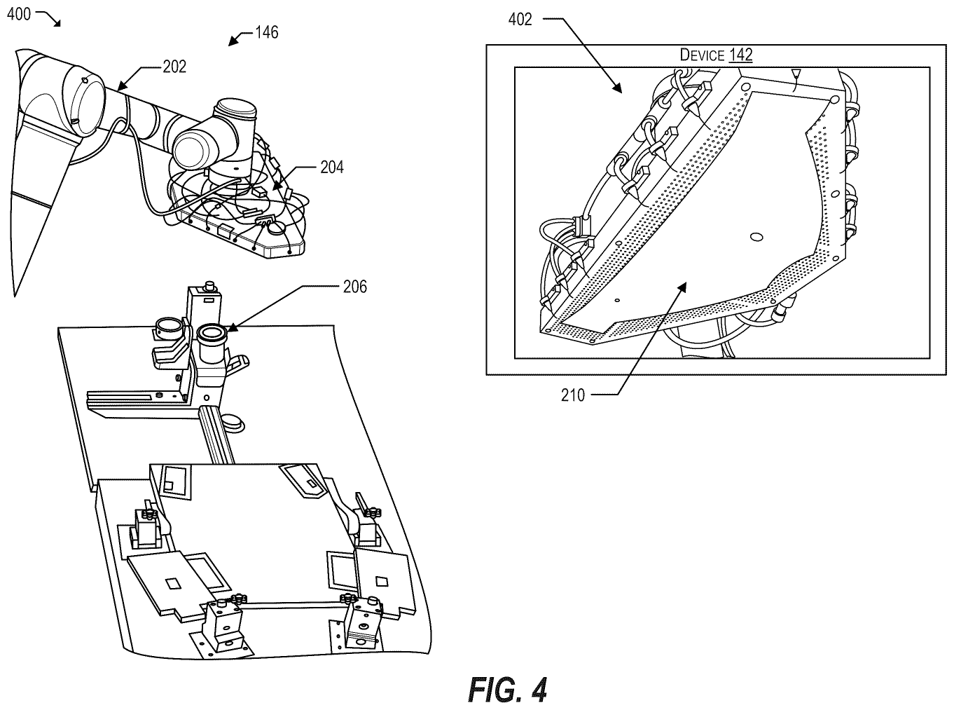

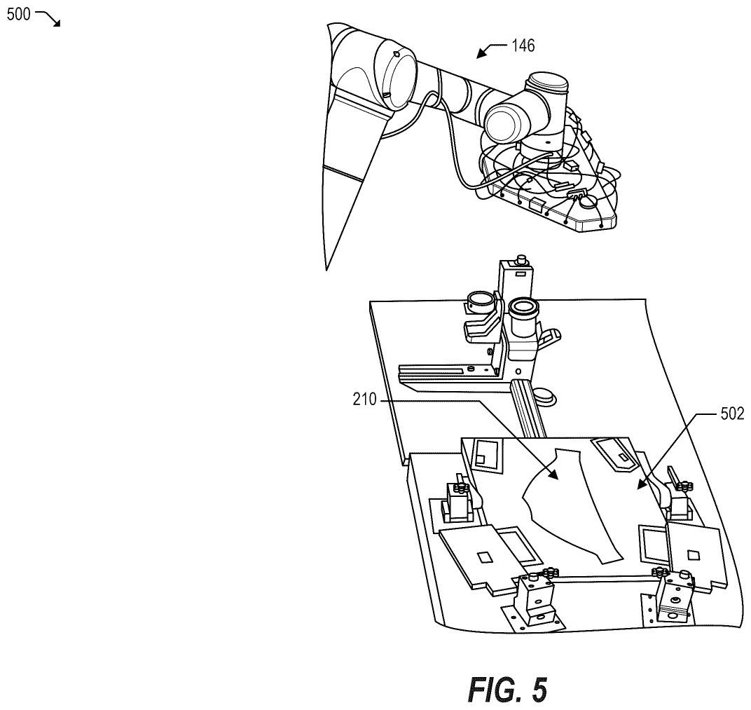

In some implementations, after the device 146 has moved along the path, the device 146 obtains another image (e.g., other image data 112) depicting the fabric on the device 146, as described in more detail in FIG. 4. In this implementation, the machine learning 132 determines wrinkle data 134 indicative of whether the fabric includes one or more wrinkles based on the other image data 112. In some aspects, the machine learning 132 determines that the fabric does not have any more wrinkles. In this aspect, the controller 136 sends the signal 140 to the device 146 to transfer the fabric 152 to device 150 as described in more detail in FIG. 5. In other aspects, the machine learning 132 determines that the fabric does have wrinkles and the process of removing the wrinkles is continued until either the wrinkles are removed or the device 102 notifies a user of the issue of being unable to remove the wrinkles.

In some implementations, the processor 118 includes a wrinkle determinator and the machine learning 132 sends the wrinkle data 134 to the wrinkle determinator. The wrinkle determinator determines whether the fabric has wrinkles based on the wrinkle data 134. In some implementations, the wrinkle determinator determines that the fabric does include one or more wrinkles. In those implementations, the wrinkle determinator sends the signal 140 to the device 146, as described above. In other implementations, the wrinkle determinator determines that the fabric does not include wrinkles and sends the signal 140 to the device 146 to transfer the fabric to another device (e.g., the device 150), as described above.

During the process of manufacturing the garment, the device 102 obtains the metric data 154. The metric data 154 is indicative of production metrics, quality metrics, machine performance metrics, material usage metrics, or process flow metrics, or a combination thereof. The metric data 154 can be provided to the machine learning 124, 128, 132, or a combination thereof, for the purposes of further training the machine learning 124, 128, 132.

A technical advantage of using the system 100 includes greater efficiency, improved quality control, and increased manufacturing flexibility through the use of processing garment data (e.g., the data 106) and generating the synthetic data 122 that enables the machine learning 124, 128, 132, or a combination thereof to generate data (e.g., the output data 126, the segmentation data 130, the wrinkle data 134) that guides garment manufacturing devices with localization information and tailors actions to be performed on a fabric based on the fabric characteristics.

FIG. 2 is a diagram that illustrates a particular implementation of a system 200 for automated garment manufacturing. The system 200 includes the device 142, the device 146, a device 206, or a combination thereof.

The device 146 includes an articulated arm 202 attached to a gripper 204. The gripper 204 may be manipulated by the articulated arm 202 to perform one or more operations. For example, the gripper 204 may be configured to retrieve the fabric. The articulated arm 202 positions the gripper 204 to be above the device 206. The device 206 is configured to capture image data (e.g., the image data 110, 112). For example, the device 206 can be a camera and use one or more imaging techniques to generate the image data. For example, the one or more imaging techniques can include thermal imaging, three-dimensional (3D) imaging, two-dimensional (2D) imaging, structured light imaging, laser scanning, digital imaging correlation, multispectral imaging, machine vision with standard cameras, or a combination thereof.

The image data can be sent to the device 142. The device 142 can include a display device configured to display an image 208 associated with the image data (e.g., the image data 110). As illustrated, the image 208 is a thermal image of the fabric 210. The fabric 210 includes one or more wrinkles 212.

As described in FIG. 1, the machine learning 132 obtains the image data 112, via the device 206 or from the memory 104, indicative of the image 208 depicting the fabric 210 on the gripper 204. The machine learning 132 determines the wrinkle data 134 indicative of the fabric 210 including the one or more wrinkles 212. The machine learning 132 sends the wrinkle data 134 to the controller 136 of FIG. 1. The controller 136 sends the signal 140 to the device 146. The signal 140 causes the gripper 204 to move, via the articulated arm 202, along a path associated with locations of the one or more wrinkles 212 to remove the one or more wrinkles 212 from the fabric 210, as described in more detail in FIG. 3. After the one or more wrinkles 212 have been removed from the fabric 210, the fabric 210 is transferred to another device associated with the manufacturing of the fabric into the garment, as described in more detail in FIG. 5.

FIG. 3 is a diagram that illustrates another particular implementation of a system 300 for automated garment manufacturing. The system 300 includes the device 142, the device 146, the device 206, a device 306, or a combination thereof.

The device 146 includes the articulated arm 202 and the gripper 204, as described in FIG. 2. The gripper 204 includes one or more devices 302 and one or more perforations 304. The one or more devices 302 are configured to blow air towards the fabric 210. The one or more perforations 304 are coupled to a vacuum assembly. The vacuum assembly may be integrated in the device 146 or coupled to the device 146. The vacuum assembly applies a suction to hold the fabric (e.g., the fabric 210 of FIG. 2). For example, the vacuum assembly applies the suction to hold the fabric in place on the gripper 204. The blowing of the air by the one or more devices 302 creates a slight separation of the fabric 210 from the gripper 204. The slight separation can be configured to allow the one or more wrinkles 212 to be removed but not allow the fabric 210 to fall from the gripper 204.

As described in FIG. 1, the machine learning 132 determines the wrinkle data indicative of the fabric 210 including the one or more wrinkles 212 based on the image data captured by the device 206. The machine learning 132 sends the wrinkle data 134 to the controller 136 of FIG. 1. The controller 136 sends the signal 140 to the device 146. The signal 140 causes the gripper 204 to move, via the articulated arm 202, to be positioned above the device 306. The signal then causes the gripper 204 to move, via the articulated arm 202, along a path associated with locations of the one or more wrinkles 212 to remove the one or more wrinkles 212 from the fabric 210. The device 306 is configured to use compressed air to remove the one or more wrinkles 212 from the fabric 210, while the gripper 204 is moving along the path. The device 306 may be the device 148 of FIG. 1.

In some implementations, after the one or more wrinkles 212 have been removed, the device 146 obtains another image (e.g., other image data), via the device 206, depicting the fabric 210 without any wrinkles on the gripper 204, as described in more detail in FIG. 4. After it is confirmed that the one or more wrinkles 212 have been removed from the fabric 210, the fabric 210 is transferred to another device associated with the manufacturing of the fabric into the garment, as described in more detail in FIG. 5.

FIG. 4 is a diagram that illustrates another particular implementation of a system 400 for automated garment manufacturing. The system 400 includes the device 142, the device 146, the device 206, or a combination thereof.

In some aspects, after the one or more wrinkles 212 have been removed, the device 146 obtains another image 402 (e.g., other image data), via the device 206, depicting the fabric 210. Image data indicative of the image 402 can be sent to the device 142. The device 142 can include a display device configured to display the image 402 of the gripper 204 holding the fabric 210. As illustrated in FIG. 4 the image 402 displayed on the device 142 shows that the fabric 210 does not include any wrinkles. As described above in FIG. 1 the machine learning 132 is configured based on the image data to determine that the fabric 210 does not include any wrinkles. The controller 136 of FIG. 1 is configured to send a signal (e.g., the signal 140) to the device 146 to transfer the fabric 210 to another device associated with the manufacturing of the fabric into the garment, as described in more detail in FIG. 5.

In some aspects, the machine learning 132, as in FIG. 1, determines that the fabric does have wrinkles based on the image 402 obtained via the device 206. In this instance, the process of removing the wrinkles continues until either the wrinkles are removed or the device 102, as in FIG. 1, notifies a user of the issue of being unable to remove the wrinkles.

In some implementations, either before the wrinkles are removed or after the wrinkles are removed, the machine learning 128 of FIG. 1, generates the segmentation data 130 indicative of pixel values associated with a location of the fabric 210 on the gripper 204. In some aspects, prior to the generation of the segmentation data 130, one or more process steps are performed on the image data as described in FIG. 1. The machine learning 128 sends the segmentation data 130 to the controller 136 of FIG. 1. The controller 136 then determines a probability 138 that the fabric 210 is in a location on the gripper 204 that is suitable for the action. The controller 136 determines whether the probability 138 satisfies the threshold 116. When the probability 138 satisfy the threshold 116, the actions performed include removal of the wrinkles, as described in FIGS. 1 and 3, transfer of fabric 210 to another device associated with the manufacturing of the fabric into the garment, as described in more detail in FIG. 5, or both.

FIG. 5 is a diagram that illustrates another particular implementation of a system 500 for automated garment manufacturing. The system 500 includes the device 146 and a device 502. The device 502 may include the device 150 as described in FIG. 1.

After it is determined that the fabric 210 is in a location on the device 146 that is suitable for an action, the one or more wrinkles are removed from the fabric 210, or both, as described in FIGS. 1-4, the device 146 transfers the fabric 210 to the device 502. As illustrated in FIG. 5, the device 502 can be a device configured to fold the fabric 210. In other implementations, the device 502 can be a device associated with the manufacturing of the fabric 210 into a garment, such as a sewing machine, robot, device configured to apply adhesive, apply other pieces of fabric to the fabric 210, apply one or more accessories to the fabric 210, and so forth. The device 502 can include or be coupled to a vacuum assembly. The vacuum assembly can apply a suction to hold the fabric 210 in place on the device 502.

During the process of manufacturing the fabric 210 into a garment, as described in FIGS. 1-5, metric data can be obtained. The metric data is indicative of production metrics, quality metrics, machine performance metrics, material usage metrics, or process flow metrics, or a combination thereof. The metric data can be provided to the machine learning (e.g., the machine learning 124, 128, 132, or a combination thereof) for the purposes of further training and refinement.

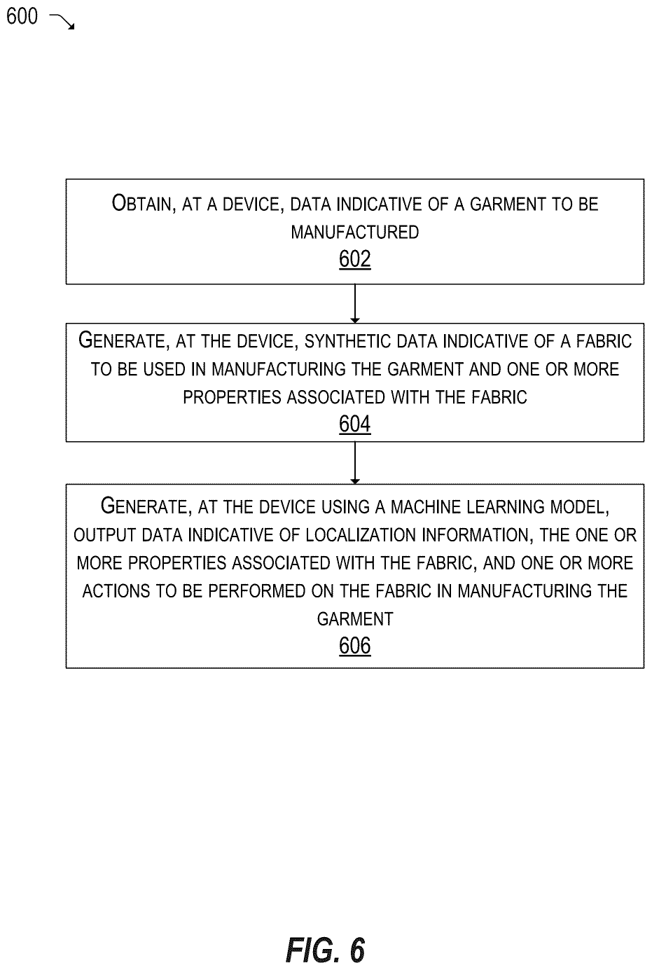

FIG. 6 is a flow chart of a method 600 for automated garment manufacturing. The method 600 includes, at block 602, obtaining, at a device, data indicative of a garment to be manufactured. For example, the device 102 of FIG. 1, is configured to obtain the data 106 indicative of a garment to be manufactured. The data 106 can include a digital design file (e.g., DXF format) containing garment measurements, seam allowances, and other specifications. Alternatively, the data can include 3D garment models or even 2D sketches that include garment measurements, seam allowances, and other specifications.

The method 600 includes, at block 604, generating, at the device, synthetic data indicative of a fabric to be used in manufacturing the garment and one or more properties associated with the fabric. For example, the synthetic data generator 120 obtains the data 106 in response to a user request to manufacture a garment. The synthetic data generator 120 generates synthetic data 122 indicative of a fabric to be used in manufacturing the garment and one or more properties associated with the fabric. The one or more properties includes one or more of fabric color, pattern or design on the fabric, fabric weight, fabric material and characteristics associated with the fabric material, fabric density, or a combination thereof. In some aspects, the generation of the synthetic data 122 further includes receiving user input to augment the synthetic data 122, such as the other data 114 indicative of information associated with the manufacturing the garment, historical data indicative of previously obtained data indicative of other garments to be manufactured, or both. The previously obtained data includes one or more previous fabrics and one or more previous properties for each of the one or more previous fabrics.

The method 600 includes, at block 606, generating, at the device using a machine learning model, output data indicative of localization information, the one or more properties associated with the fabric, and one or more actions to be performed on the fabric in manufacturing the garment. For example, the machine learning 124 generates the output data 126 indicative of localization information, one or more properties associated with the fabric, and one or more actions associated with the fabric to be performed on the fabric in manufacturing the garment. The machine learning 124 can send the output data 126 to the device 142 to be displayed to a user. In some aspects, the machine learning 124 sends the output data 126 to the controller 136 and the controller 136 then sends the output data 126 to the device 142.

In some implementations, the method 600 can include more, fewer, and/or different steps without departing from the scope of the subject disclosure. For example, the method 600 can include the additional steps of obtaining, at the device, image data indicative of an image depicting the fabric on a first device; generating, at the device using a second machine learning model, segmentation data indicative of pixel values associated with a location of the fabric on the first device within the image; determining, at the device, a probability that the fabric is in a location on the first device that is suitable for one or more manufacturing processes to be performed on the fabric; and in response to the probability satisfying a threshold, causing a second device to perform the one or more actions. These additional steps can be performed using the systems 100, 200, 300, 400, 500, or a combination thereof, as described in FIGS. 1-5.

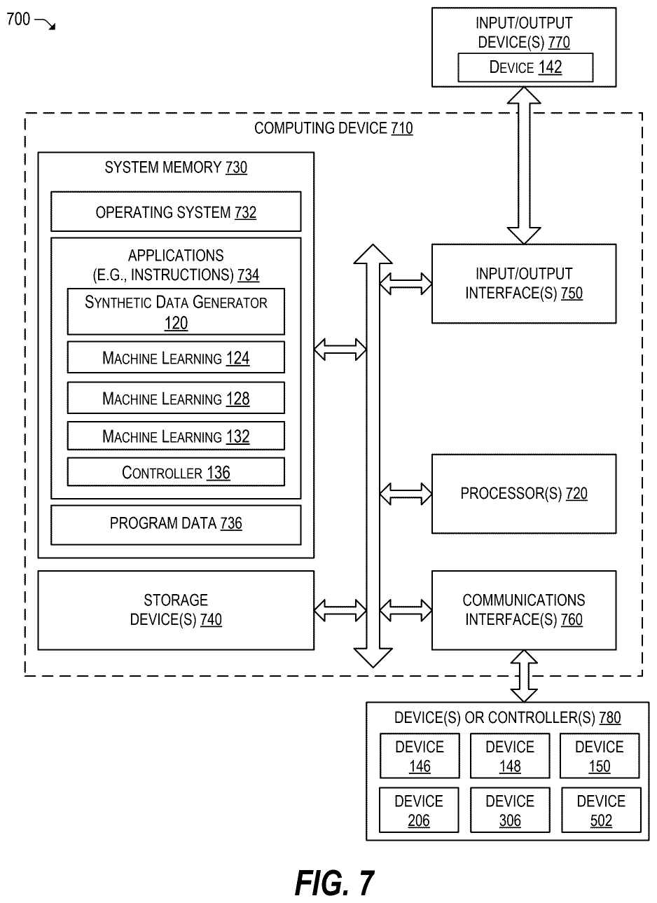

FIG. 7 is a block diagram of a computing environment 700 including a computing device 710 configured to support aspects of computer-implemented methods and computer-executable program instructions (or code) according to the present disclosure. For example, the computing device 710, or portions thereof, is configured to execute instructions to initiate, perform, or control one or more operations described with reference to FIGS. 1-7.

The computing device 710 includes one or more processors 720. In some aspects, the processor(s) 720 correspond to the processor(s) 118 of FIG. 1. The processor(s) 720 are configured to communicate with system memory 730, one or more storage devices 740, one or more input/output interfaces 750, one or more communications interfaces 760, or any combination thereof. The system memory 730 includes volatile memory devices (e.g., random access memory (RAM) devices), nonvolatile memory devices (e.g., read-only memory (ROM) devices, programmable read-only memory, and flash memory), or both. The system memory 730 stores an operating system 732, which may include a basic input/output system for booting the computing device 710 as well as a full operating system to enable the computing device 710 to interact with users, other programs, and other devices. The system memory 730 stores system program data 736, such as any data used or generated by the system 100, the device 102, the device 142, the device 146, the device 148, the device 150, the synthetic data generator 120, the machine learning 124, the machine learning 128, the machine learning 132, the controller, 136, the device 206, the device 306, the device 502, the system 200, the system 300, the system 400, the system 500, one or more modules, one or more machine learning models, or a combination thereof, as described with reference to FIGS. 1-6.

The system memory 730 includes one or more applications 734 (e.g., sets of instructions) executable by the processor(s) 720. As an example, the one or more applications 734 include instructions executable by the processor(s) 720 to initiate, control, or perform one or more operations described with reference to FIGS. 1-6. To illustrate, the one or more applications 734 include instructions executable by the processor(s) 720 to initiate, control, or perform one or more operations described with reference to the synthetic data generator 120, the machine learning 124, the machine learning 128, the machine learning 132, the controller 136, or a combination thereof.

In a particular implementation, the system memory 730 includes a non-transitory, computer readable medium storing the instructions that, when executed by the processor(s) 720, cause the processor(s) 720 to initiate, perform, or control operations to aid in generating, at the device, synthetic data indicative of a fabric to be used in manufacturing the garment and one or more properties associated with the fabric, and generating, at the device using a machine learning model, output data indicative of localization information, the one or more properties associated with the fabric, and one or more actions to be performed on the fabric in manufacturing the garment. For example, the instructions, when executed by the processor(s) 720, cause the processor(s) 720 to obtain data indicative of a garment to be manufactured, generate synthetic data indicative of a fabric to be used in manufacturing the garment and one or more properties associated with the fabric, and generate output data indicative of localization information, the one or more properties associated with the fabric, and one or more actions to be performed on the fabric in manufacturing the garment.

The one or more storage devices 740 include nonvolatile storage devices, such as magnetic disks, optical disks, or flash memory devices. In a particular example, the storage devices 740 include both removable and non-removable memory devices. The storage devices 740 are configured to store an operating system, images of operating systems, applications (e.g., one or more of the applications 734), and program data (e.g., the program data 736). In a particular aspect, the system memory 730, the storage devices 740, or both, include tangible computer-readable media. In a particular aspect, one or more of the storage devices 740 are external to the computing device 710. In some aspects, the system memory 730, the storage devices 740, or both, correspond to the memory 104 of FIG. 1.

The one or more input/output interfaces 750 enable the computing device 710 to communicate with one or more input/output devices 770 to facilitate user interaction. For example, the one or more input/output interfaces 750 can include a display interface, an input interface, or both. For example, the input/output interface 750 is adapted to receive input from a user, to receive input from another computing device, or a combination thereof. In some implementations, the input/output interface 750 conforms to one or more standard interface protocols, including serial interfaces (e.g., universal serial bus (USB) interfaces or Institute of Electrical and Electronics Engineers (IEEE) interface standards), parallel interfaces, display adapters, audio adapters, or custom interfaces (“IEEE” is a registered trademark of The Institute of Electrical and Electronics Engineers, Inc. of Piscataway, New Jersey). In some implementations, the input/output device 770 includes one or more user interface devices and displays (e.g., device 142), including some combination of buttons, keyboards, pointing devices, displays, speakers, microphones, touch screens, and other devices.

The processor(s) 720 are configured to communicate with devices or controllers 780 via the one or more communications interfaces 760. For example, the one or more communications interfaces 760 can include a network interface. The devices or controllers 780 can include, for example, the device 146, the device 148, the device 150, the device 206, the device 306, the device 502, or a combination thereof.

In some implementations, a non-transitory, computer readable medium stores instructions that, when executed by one or more processors, cause the one or more processors to initiate, perform, or control operations to perform part or all of the functionality described above. For example, the instructions may be executable to implement one or more of the operations or methods of FIGS. 1-6. In some implementations, part, or all of one or more of the operations or methods of FIGS. 1-6 may be implemented by one or more processors (e.g., one or more central processing units (CPUs), one or more graphics processing units (GPUs), one or more digital signal processors (DSPs)) executing instructions, by dedicated hardware circuitry, or any combination thereof.

The illustrations of the examples described herein are intended to provide a general understanding of the structure of the various implementations. The illustrations are not intended to serve as a complete description of all of the elements and features of apparatus and systems that utilize the structures or methods described herein. Many other implementations can be apparent to those of skill in the art upon reviewing the disclosure. Other implementations can be utilized and derived from the disclosure, such that structural and logical substitutions and changes can be made without departing from the scope of the disclosure. For example, method operations can be performed in a different order than shown in the figures or one or more method operations can be omitted. Accordingly, the disclosure and the figures are to be regarded as illustrative rather than restrictive.

Moreover, although specific examples have been illustrated and described herein, it should be appreciated that any subsequent arrangement designed to achieve the same or similar results can be substituted for the specific implementations shown. This disclosure is intended to cover any and all subsequent adaptations or variations of various implementations. Combinations of the above implementations, and other implementations not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features can be grouped together or described in a single implementation for the purpose of streamlining the disclosure. Examples described above illustrate but do not limit the disclosure. It should also be understood that numerous modifications and variations are possible in accordance with the principles of the subject disclosure. As the following claims reflect, the claimed subject matter can be directed to less than all of the features of any of the disclosed examples. Accordingly, the scope of the disclosure is defined by the following claims and their equivalents.

Particular aspects of the disclosure are described below in sets of interrelated Examples:

According to Example 1, a device includes one or more processors coupled to a memory and configured to obtain data indicative of a garment to be manufactured; generate, using a machine learning model trained on the data, output data indicative of localization information, one or more properties associated with a fabric, and one or more actions associated with the fabric to be performed on the fabric in manufacturing the garment; and cause a second device to perform an action of the one or more actions associated with the fabric.

Example 2 includes the device of Example 1, wherein the one or more processors are further configured to obtain second data indicative of information associated with said manufacturing the garment.

Example 3 includes the device of Example 1 or Example 2, wherein the one or more processors are further configured to obtain image data indicative of an image depicting the fabric on a fabric joining device; generate, using a second machine learning model, segmentation data indicative of pixel values associated with a location of the fabric on the fabric joining device within the image; determine a probability that the fabric is in a location on the fabric joining device that is suitable for the action; and wherein performing the action comprises performing the action in response to the probability satisfying a threshold.

Example 4 includes the device of Example 3, wherein the one or more processors are further configured to, prior to generation of the segmentation data, perform one or more processing steps to the image data, wherein the one or more processing steps includes one or more of: perform an imaging processing step to the image data, or adjust one or more-pixel values within the image data based on one or more properties associated with the fabric.

Example 5 includes the device of any of Example 1 to Example 4, wherein the one or more processors are further configured to obtain image data indicative of an image depicting the fabric on a fabric joining device; generate, using a second machine learning model, segmentation data indicative of pixel values associated with a location of the fabric on the fabric joining device within the image; determine a probability that the fabric is in a location on the fabric joining device that is suitable for the action; and wherein performing the action comprises in response to the probability not satisfying a threshold, cause a second device to discard the fabric.

Example 6 includes the device of any of Example 1 to Example 5, wherein the one or more processors are further configured to obtain image data indicative of an image depicting the fabric on a fabric joining device; based on the image data, determine, using a third machine learning model, that the fabric includes one or more wrinkles; and wherein performing the action comprises causing a second device to move along a path associated with locations of the one or more wrinkles above a third device to remove the one or more wrinkles from the fabric.

Example 7 includes the device of Example 6, wherein the third device uses compressed air to remove the one or more wrinkles from the fabric.

Example 8 includes the device of Example 6, wherein the one or more processors are further configured to determine a probability that the one or more wrinkles in the fabric has been removed; and wherein performing the action comprises causing, in response to the probability satisfying a threshold, the second device to transfer the fabric to a fourth device.

Example 9 includes the device of Example 6, wherein the one or more processors are further configured to determine a probability that the one or more wrinkles in the fabric has been removed; and in response to the probability not satisfying a threshold, cause the second device to discard the fabric.

Example 10 includes the device of Example 6, wherein the third machine learning model is trained on synthetic data indicative of wrinkled fabric images.

According to Example 11, a device includes one or more processors coupled to a memory and configured to obtain data indicative of a garment to be manufactured; generate, based on the data, synthetic data indicative of a fabric to be used in manufacturing the garment and one or more properties associated with the fabric; and train a machine learning model using the synthetic data, the machine learning model configured to output data indicative of localization information, one or more properties associated with the fabric, and one or more actions associated with the fabric to be performed on the fabric in manufacturing the garment.

Example 12 includes the device of Example 11, wherein the one or more processors are further configured to obtain second data indicative of information associated with said manufacturing the garment.

Example 13 includes the device of Example 11 or Example 12, wherein the one or more processors are further configured to train the machine learning model using the synthetic data, second data, or both.

Example 14 includes the device of any of Example 11 to Example 13, wherein the one or more processors are further configured to obtain metric data indicative of production metrics, quality metrics, machine performance metrics, material usage metrics, process flow metrics, or a combination thereof.

Example 15 includes the device of any of Example 11 to Example 14, wherein the generation of the synthetic data further includes receiving user input to augment the synthetic data, historical data indicative of previously obtained data indicative of other garments to be manufactured, or both, and wherein the previously obtained data includes one or more previous fabrics and one or more previous properties for each of the one or more previous fabrics.

Example 16 includes the device of any of Example 11 to Example 15, wherein the one or more properties includes one or more of: fabric color, pattern or design on the fabric, fabric weight, fabric material and characteristics associated with the fabric material, fabric density, or a combination thereof.

According to Example 17, a method includes obtaining, at a device, data indicative of a garment to be manufactured; generating, at the device, synthetic data indicative of a fabric to be used in manufacturing the garment and one or more properties associated with the fabric; and generating, at the device using a machine learning model, output data indicative of localization information, the one or more properties associated with the fabric, and one or more actions to be performed on the fabric in manufacturing the garment.

Example 18 includes the method of Example 17, further comprising obtaining, at the device, second data indicative of information associated with the manufacturing of the fabric into the garment.

Example 19 includes the method of Example 17 or Example 18, further comprising obtaining, at the device, metric data indicative of production metrics, quality metrics, machine performance metrics, material usage metrics, process flow metrics, or a combination thereof.

Example 20 includes the method of any of Example 17 to Example 19, further includes obtaining, at the device, image data indicative of an image depicting the fabric on a first device; generating, at the device using a second machine learning model, segmentation data indicative of pixel values associated with a location of the fabric on the first device within the image; determining, at the device, a probability that the fabric is in a location on the first device that is suitable for one or more manufacturing processes to be performed on the fabric; and in response to the probability satisfying a threshold, causing a second device to perform the one or more actions.

What is claimed is:

1. A device comprising:
one or more processors coupled to a memory and configured to:
obtain data indicative of a garment to be manufactured;
generate, using a machine learning model trained on the data, output data indicative of localization information, one or more properties associated with a fabric, and one or more actions associated with the fabric to be performed on the fabric in manufacturing the garment; and
cause a second device to perform an action of the one or more actions associated with the fabric.

2. The device of claim 1, wherein the one or more processors are further configured to obtain second data indicative of information associated with said manufacturing the garment.

3. The device of claim 1, wherein the one or more processors are further configured to:
obtain image data indicative of an image depicting the fabric on a fabric joining device;
generate, using a second machine learning model, segmentation data indicative of pixel values associated with a location of the fabric on the fabric joining device within the image;
determine a probability that the fabric is in a location on the fabric joining device that is suitable for the action; and
wherein performing the action comprises performing the action in response to the probability satisfying a threshold.

4. The device of claim 3, wherein the one or more processors are further configured to, prior to generation of the segmentation data, perform one or more processing steps to the image data, wherein the one or more processing steps includes one or more of:
perform an imaging processing step to the image data, or
adjust one or more-pixel values within the image data based on one or more properties associated with the fabric.

5. The device of claim 1, wherein the one or more processors are further configured to:
obtain image data indicative of an image depicting the fabric on a fabric joining device;
generate, using a second machine learning model, segmentation data indicative of pixel values associated with a location of the fabric on the fabric joining device within the image;
determine a probability that the fabric is in a location on the fabric joining device that is suitable for the action; and
wherein performing the action comprises in response to the probability not satisfying a threshold, cause a second device to discard the fabric.

6. The device of claim 1, wherein the one or more processors are further configured to:
obtain image data indicative of an image depicting the fabric on a fabric joining device;
based on the image data, determine, using a third machine learning model, that the fabric includes one or more wrinkles; and
wherein performing the action comprises causing a second device to move along a path associated with locations of the one or more wrinkles above a third device to remove the one or more wrinkles from the fabric.

7. The device of claim 6, wherein the third device uses compressed air to remove the one or more wrinkles from the fabric.

8. The device of claim 6, wherein the one or more processors are further configured to:
determine a probability that the one or more wrinkles in the fabric has been removed; and
wherein performing the action comprises causing, in response to the probability satisfying a threshold, the second device to transfer the fabric to a fourth device.

9. The device of claim 6, wherein the one or more processors are further configured to:
determine a probability that the one or more wrinkles in the fabric has been removed; and
in response to the probability not satisfying a threshold, cause the second device to discard the fabric.

10. The device of claim 6, wherein the third machine learning model is trained on synthetic data indicative of wrinkled fabric images.

11. A device comprising:
one or more processors coupled to a memory and configured to:
obtain data indicative of a garment to be manufactured;
generate, based on the data, synthetic data indicative of a fabric to be used in manufacturing the garment and one or more properties associated with the fabric; and
train a machine learning model using the synthetic data, the machine learning model configured to output data indicative of localization information, one or more properties associated with the fabric, and one or more actions associated with the fabric to be performed on the fabric in manufacturing the garment.

12. The device of claim 11, wherein the one or more processors are further configured to obtain second data indicative of information associated with said manufacturing the garment.

13. The device of claim 12, wherein the one or more processors are further configured to train the machine learning model using the synthetic data, second data, or both.

14. The device of claim 11, wherein the one or more processors are further configured to obtain metric data indicative of production metrics, quality metrics, machine performance metrics, material usage metrics, process flow metrics, or a combination thereof.

15. The device of claim 11, wherein the generation of the synthetic data further includes receiving user input to augment the synthetic data, historical data indicative of previously obtained data indicative of other garments to be manufactured, or both, and wherein the previously obtained data includes one or more previous fabrics and one or more previous properties for each of the one or more previous fabrics.

16. The device of claim 11, wherein the one or more properties includes one or more of:
fabric color,
pattern or design on the fabric,
fabric weight,
fabric material and characteristics associated with the fabric material,
fabric density, or a combination thereof.

17. A method comprising:
obtaining, at a device, data indicative of a garment to be manufactured;
generating, at the device, synthetic data indicative of a fabric to be used in manufacturing the garment and one or more properties associated with the fabric; and
generating, at the device using a machine learning model, output data indicative of localization information, the one or more properties associated with the fabric, and one or more actions to be performed on the fabric in manufacturing the garment.

18. The method of claim 17, further comprising obtaining, at the device, second data indicative of information associated with the manufacturing of the fabric into the garment.

19. The method of claim 17, further comprising obtaining, at the device, metric data indicative of production metrics, quality metrics, machine performance metrics, material usage metrics, process flow metrics, or a combination thereof.

20. The method of claim 17, further comprising:
obtaining, at the device, image data indicative of an image depicting the fabric on a first device;
generating, at the device using a second machine learning model, segmentation data indicative of pixel values associated with a location of the fabric on the first device within the image;
determining, at the device, a probability that the fabric is in a location on the first device that is suitable for one or more manufacturing processes to be performed on the fabric; and
in response to the probability satisfying a threshold, causing a second device to perform the one or more actions.
